(19) United States
(12) Patent Application Publication
(10) Pub. No.: US 2019/0289678 A1
(43) Pub. Date: Sep. 19, 2019

(54) SAFE OPERATING AREA CONTROL METHOD FOR AN INDUCTION COOKING SYSTEM

(71) Applicant: Haier US Appliance Solutions, Inc., Wilmington, DE (US)

(72) Inventors: Isaac Nam, Louisville, KY (US); Ali Jordan Faraji-Tajrishi, Louisville, KY (US); Victoria Steele, Louisville, KY (US)

(21) Appl. No.: 15/923,074

(22) Filed: Mar. 16, 2018

(51) Int. Cl. H05B 6/06; H05B 6/12

(52) U.S. Cl. CPC H05B 6/062; H05B 2206/02; H05B 6/1209

(57) ABSTRACT

A method of operating an induction cooktop appliance includes supplying a power signal to an induction heating element of the induction cooktop appliance in response to a request received via a user input of the cooktop appliance. The method also includes detecting a current of the power signal supplied to the induction heating element and detecting a phase angle of the power signal supplied to the induction heating element. The method may further include determining a maximum current based on the detected phase angle, comparing the detected current to the determined maximum current, and modifying an operating parameter of the induction cooktop appliance when the detected current is greater than the determined maximum current.

### FIELD OF THE INVENTION

The present disclosure relates to an induction cooking appliance and more particularly to a system and method for controlling the induction cooking appliance to promote improved operation of the cooktop appliance.

### BACKGROUND OF THE INVENTION

Induction cooking appliances are more efficient, have greater temperature control precision and provide more uniform cooking than other conventional cooking appliances. In conventional cooktop systems, an electric or gas heat source is used to heat cookware in contact with the heat source. This type of cooking is inefficient because only the portion of the cookware in contact with the heat source is directly heated. The rest of the cookware is heated through conduction that causes non-uniform cooking throughout the cookware. Heating through conduction takes an extended period of time to reach a desired temperature.

In contrast, induction cooking systems use electromagnetism which turns cookware of the appropriate material into a heat source. Such appropriate materials may include ferromagnetic materials in order to effectively capture the magnetic field produced by the induction cooking coil. Other materials, such as aluminum, will be very inefficient for cooking on an induction cooking system. A power supply provides a signal having a frequency to the induction coil. When the coil is activated a magnetic field is produced which induces a current on the bottom surface of the cookware. The induced current on the bottom surface then induces even smaller currents (Eddy currents) within the cookware thereby providing heat throughout the cookware.

A typical power supply of an induction cooking system may include a resonant inverter to achieve soft-switching conditions such as zero voltage switching and zero current switching. However, when there is poor magnetic coupling between a cookware and the induction coil, e.g., due to cookware of inappropriate material and/or dimensions, undesirable operating conditions, including hard switching can occur.

Therefore, a need exists for a system and method of controlling an induction cooking appliance that overcomes the above mentioned disadvantages. A system and method that could control an induction cooking appliance to ensure that the induction cooking appliance operates within a safe operating zone would be useful.

### BRIEF DESCRIPTION OF THE INVENTION

The present invention provides induction cooktop appliances and related methods of controlling such appliances to maintain power levels within a safe operating zone, e.g., to avoid or minimize hard switching. Aspects and advantages of the invention will be set forth in part in the following description, or may be obvious from the description, or may be learned through practice of the invention.

In one exemplary aspect of the present subject matter, an induction cooktop appliance is provided. The induction cooktop appliance includes a user interface, an induction heating element, a power supply circuit, and a control circuit. The user interface includes a user input. The induction heating element is operable to inductively heat a load with a magnetic field. The power supply circuit is configured to supply a power signal to the induction heating element. The power supply circuit includes an inverter. The control circuit is configured to control the power supply circuit. The control circuit is also configured to activate the power supply circuit in response to a request received via the user input, detect a current of the power signal supplied to the induction heating element, detect a phase angle of the power signal supplied to the induction heating element and determine a maximum current based on the detected phase angle. The control circuit is further configured to compare the detected current to the determined maximum current and modify an operating parameter of the power supply circuit when the detected current is greater than the determined maximum current.

In another exemplary aspect of the present subject matter, a method of operating an induction cooktop appliance is provided. The method includes supplying a power signal to an induction heating element of the induction cooktop appliance in response to a request received via a user input of the cooktop appliance. The method also includes detecting a current of the power signal supplied to the induction heating element and detecting a phase angle of the power signal supplied to the induction heating element. The method may further include determining a maximum current based on the detected phase angle, comparing the detected current to the determined maximum current, and modifying an operating parameter of the induction cooktop appliance when the detected current is greater than the determined maximum current.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a top, perspective view of an exemplary induction cooking system of the present disclosure.

FIG. 2 provides a schematic view of the induction cooktop appliance of FIG. 1 with an induction heating element of the induction cooktop appliance shown heating a cooking utensil supported on the induction cooktop appliance.

FIG. 3 provides a block diagram of an induction heating system according to an exemplary embodiment of the present subject matter.

FIG. 4 provides a circuit diagram of an exemplary inverter usable with one or more embodiments of the present subject matter.

FIG. 5 provides an exemplary graphical depiction of current and voltage levels associated with a switching element and an induction heating coil.

FIG. 6 provides an exemplary graphical depiction of coil current versus operating frequency of an induction heating coil.

FIG. 7 provides an exemplary graphical depiction of phase angle versus operating frequency of an induction heating coil.

FIG. 8 provides an exemplary graphical depiction of a relationship between coil current and phase angle.

FIG. 9 provides a flow chart of a method of controlling an induction cooktop appliance according to one or more exemplary embodiments of the present subject matter.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

The systems and methods of the present disclosure are described with reference to an induction cooking system. Those of ordinary skill in the art, using the disclosures provided herein, will appreciate that the systems and methods of the present disclosure are more broadly applicable to many resonant power supply technologies.

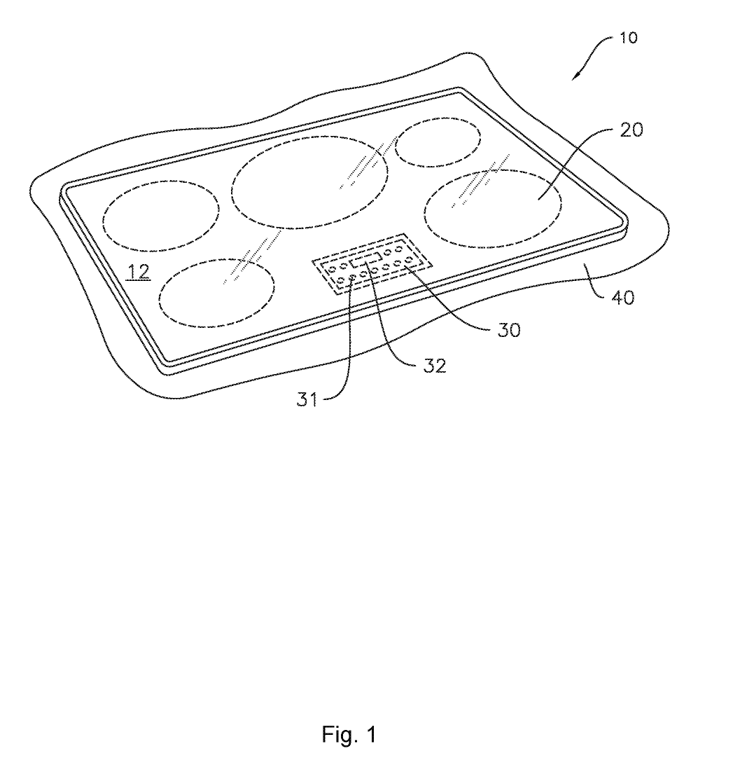

FIG. 1 provides an exemplary embodiment of an induction cooking appliance 10 of the present invention. Cooktop 10 may be installed in a chassis 40 and in various configurations such as in cabinetry in a kitchen, coupled with one or more ovens or as a stand-alone appliance. Chassis 40 may be grounded. Cooktop 10 includes a horizontal surface 12 that may be glass. Induction heating element 20 may be provided below horizontal surface 12. It may be understood that cooktop 10 may include a single induction heating element or a plurality of induction heating elements.

Cooktop 10 is provided by way of example only. The present invention may be used with other configurations. For example, a cooktop having one or more induction heating elements in combination with one or more electric or gas burner assemblies. In addition, the present invention may also be used with a cooktop having a different number and/or positions of heating elements.

A user interface 30 may have various configurations and controls may be mounted in other configurations and locations other than as shown in FIG. 1. In the illustrated embodiment, the user interface 30 may be located within a portion of the horizontal surface 12, as shown. Alternatively, the user interface may be positioned on a vertical surface near a front side of the cooktop 10 or anywhere a user may locate during operation of the cooktop. The user interface 30 may allow for the selective activation, adjustment or control of any or all induction heating elements 20 as well as any timer features or other user adjustable inputs. One or more of a variety of electrical, mechanical or electro-mechanical user input devices including rotary dials, push buttons, and touch pads may also be used singularly or in combination with the capacitive touch screen input device component 31. The user interface 30 may include a display component 32, such as a digital or analog display device designed to provide operational feedback to a user.

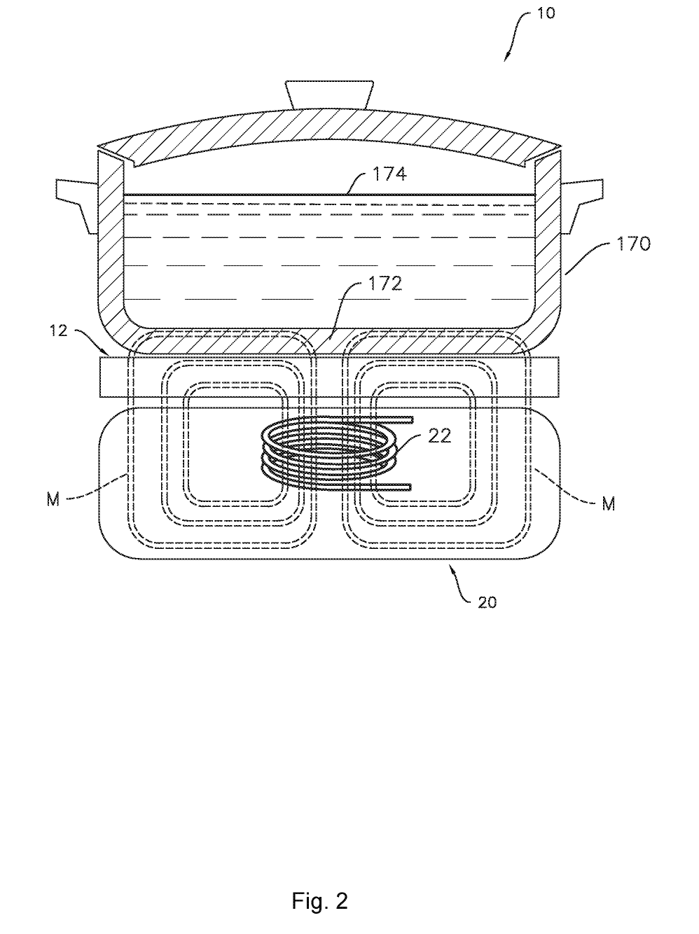

FIG. 2 provides a schematic view of induction cooktop appliance 10 with one of induction heating elements 20 shown heating a cooking utensil 170 supported on horizontal surface 12. Induction heating element 20 includes a Lenz coil or wire 22. As will be understood by those skilled in the art, cooktop appliance 10 can supply a current to Lenz coil 22. As such current passes through Lenz coil 22, Lenz coil 22 generates a magnetic field (shown with dashed lines M). The magnetic field can be a high frequency circulating magnetic field. As shown in FIG. 2, Lenz coil 22 can be oriented such that magnetic field M is directed towards and through horizontal surface 12 to cooking utensil 170. In particular, when magnetic field M penetrates cooking utensil 170, magnetic field M induces a circulating electrical current within cooking utensil 170, e.g., within a bottom wall 172 of cooking utensil 170. The material properties of cooking utensil 170 restrict a flow of the induced electrical current and convert the induced electrical current into heat within cooking utensil 170. As cooking utensil 170 heats up, contents 174 of cooking utensil 170 contained therein heat up as well. In such a manner, induction heating element 120 can cook contents 174 of cooking utensil 170.

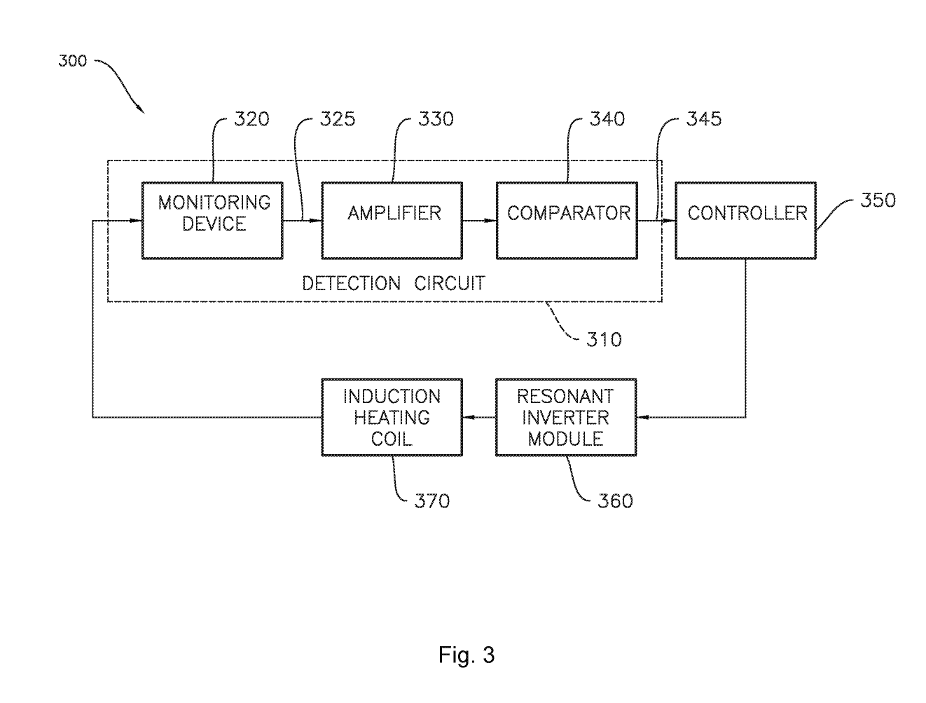

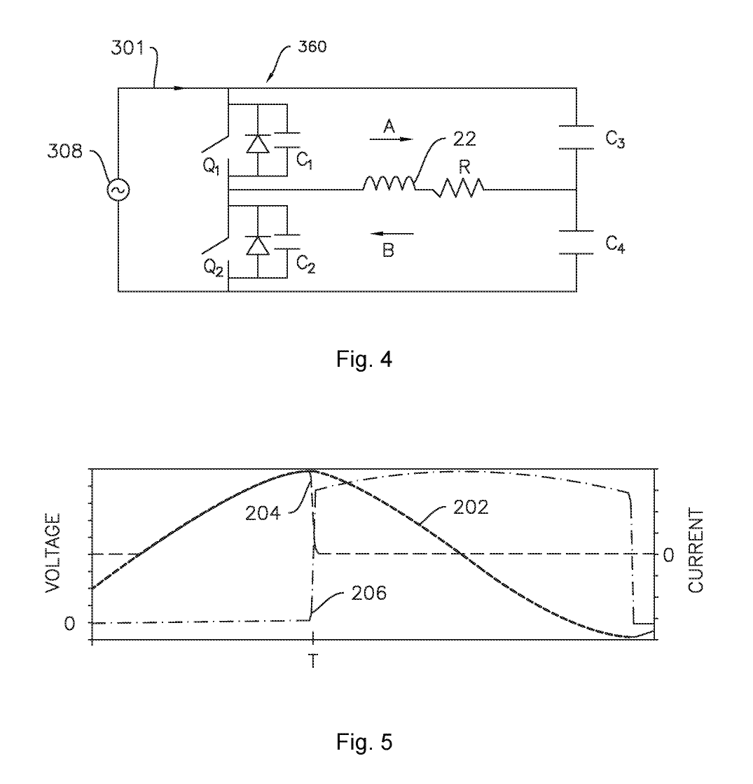

FIG. 3 is a schematic block diagram of an induction heating system 300 according to an exemplary embodiment of the present disclosure. The induction heating system 300 can include a detection circuit 310, a control circuit or controller 350, a power supply circuit such as resonant inverter module 360, and an induction heating coil 370, e.g., in some embodiments the induction heating coil 370 may be the coil 22 shown in FIG. 2 and described above. The resonant inverter module 360 can be configured to supply a chopped DC power signal to induction heating coil 370 at a desired operating frequency. The topology of the resonant inverter module 360 may, in some exemplary embodiments, be a half-bridge resonant inverter such as the exemplary inverter illustrated in FIG. 4. In other embodiments, a full-bridge resonant inverter and/or other similar resonant inverter topology may be provided.

Referring still to FIG. 3, the detection circuit 310 can include a monitoring device 320. Monitoring device 320 can be configured to detect and measure a current flow through induction heating coil 370. The monitoring device 320 can generate a feedback signal 325 associated with the current flow through the induction heating coil 370. The feedback signal 325 can be amplified at amplifier 330 and can be provided to comparator 340. Those of ordinary skill in the art, using the disclosures provided herein, will understand that other signal conditioning devices, such as filters, shifters, analog-to-digital converters, etc., can be used to condition the feedback signal for processing.

Comparator 340 can be configured to compare the feedback signal 325 with a reference signal to generate an output signal 345 that can be provided to controller 350. In one implementation, the output signal 345 can be provided to an analog-to-digital converter. As will be discussed in more detail below, the output signal 345 provides information to the controller 350 concerning the current, e.g., amperage, and the phase angle of a power signal provided to the induction heating system 300. The controller 350 is capable of and may be operable to perform any methods and associated method steps as disclosed herein. For example, in some embodiments, methods disclosed herein may be embodied in programming instructions stored in a memory and executed by the controller 350.

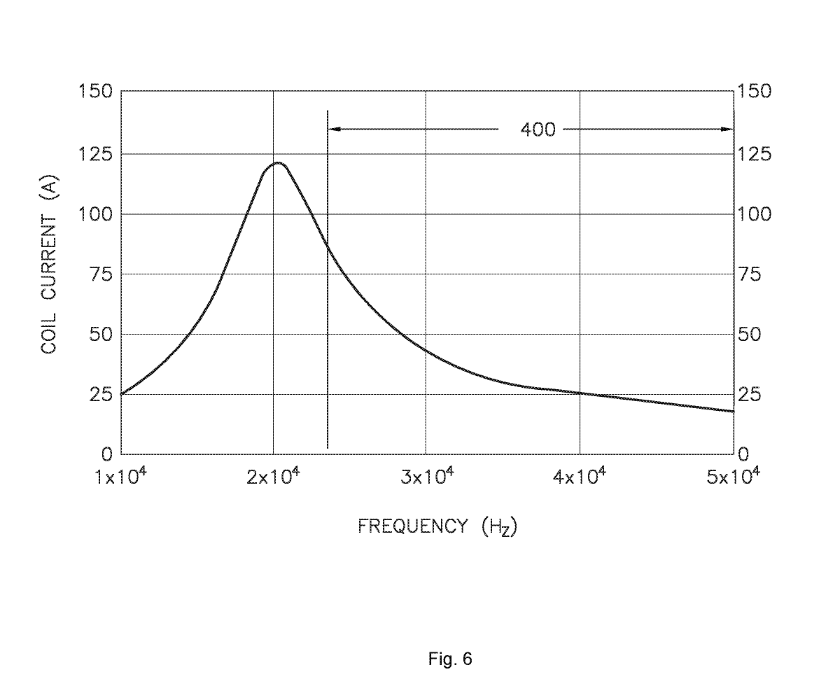

An exemplary resonant power inverter circuit is illustrated in FIG. 4, e.g., one possible example embodiment of the resonant inverter module 360 shown in FIG. 3. The illustrated example in FIG. 4 includes half-bridge resonant inverter topology. As mentioned above, additional possible example circuits may include a full-bridge resonant inverter topology, other resonant tank topologies, or any other suitable topology. As shown, the induction heating coil 22 can receive a power signal 301 that is supplied through a resonant power inverter, referred to herein as a resonant inverter module 360. The resonant inverter module 360 can be generally configured to generate a high frequency power signal from AC power source 308 at a desired operating frequency to the induction heating coil 114. For example, as described in more detail below with reference to FIGS. 5 and 6, the operating frequency may range from about twenty-five kilohertz (25 kHz) to about fifty kilohertz (50 kHz). The load of the resonant inverter module 360 can generally include the induction heating coil 22 and any object or cookware (e.g., cookware 170 as described above in reference to FIG. 2) that is present on the induction heating coil 22.

The resonant inverter module 360 can be coupled to AC power source 308. The resonant inverter module 360 can be provided with switching elements Q1 and Q2, which can provide power to the load, including the induction heating coil 22 and any cookware or object thereon. The direction A, B of the current flow through the induction heating coil 114 can be controlled by the switching of switching elements Q1 and Q2. A switching unit (not shown) can provide the controlled switching of the switching elements Q1, Q2 based on a switching control signal provided from controller 350 (FIG. 3). For example, the switching unit may be a Pulse Width Modulation (PWM) controlled half bridge gate driver integrated circuit; the structure and function of such switching units is well understood in the art and therefore not described in further detail herein.

Switching elements Q1 and Q2 may be bidirectional, e.g., metal-oxide-semiconductor field-effect transistors (MOSFETs). In other embodiments, switching elements Q1 and Q2 may be unidirectional, e.g., insulated-gate bipolar transistors (IGBTs). In alternate embodiments, any suitable switching elements can be used. Snubber capacitors C1, C2 and resonant capacitors C3, C4 can be connected between a positive power terminal and a negative power terminal to successively resonate with the induction heating coil 22. The induction heating coil 22 can be connected between the switching elements Q1, Q2 and can induce an eddy current in the cookware 170 (FIG. 2) located on or near the induction heating coil 22. In particular, the generated resonant currents can induce a magnetic field coupled to the cookware 170, inducing eddy currents in the cookware 170. The eddy currents can heat the cookware 170 on the induction heating coil 22 as described above.

The resonant inverter module 360 can power the induction heating coil 22 with high frequency current. The switching of the switching elements Q1 and Q2 by controller 350, e.g., via a switching unit, can control the direction A, B and frequency of this current. If switching element Q1 is turned on and switching element Q2 is turned off, the resonance capacitor C3 and the induction coil 22 (including any cookware thereon) can form a resonant circuit. If the switching element Q1 is turned off and switching element Q2 is turned on, the resonance capacitor C4 and the induction coil 22 (including any cookware thereon) can form the resonant circuit. In each case, the resonant circuit may be damped by a resistor R.

FIG. 5 provides an exemplary graphical depiction of current and voltage levels associated with a switching element and an induction heating coil of an exemplary resonant power inverter circuit. In particular, FIG. 5 shows a coil current 202, a switching element current 204, and a switching element voltage 206. For example, coil current 202 can be the current flowing through induction heating coil 22 of FIG. 4, switching element current 204 can be the current flowing through switching element Q1 of FIG. 4, and switching element voltage 206 can be the voltage across switching element Q1 of FIG. 4. In some instances, as depicted in FIG. 5, switching element Q1 may be switched off at time T, when coil current 202 is at its peak amplitude. Switching element Q2 (voltage and current not depicted) will then be switched on. In such fashion, the voltage across the induction heating coil can be reversed. However, when switching element Q1 is switched off at time T, switching element Q1 can experience a switching power loss. Such switching loss can be generally proportional to the corresponding coil current. Thus, when the peak amplitude of coil current 202 is relatively high, the resulting switching power loss can exceed the switching element's safe operating area and the switching element can be damaged. Excessive switching power loss may be especially problematic in instances in which magnetic coupling between a vessel or cookware and the induction heating coil 22 is poor, e.g., when there is a low coupling coefficient.

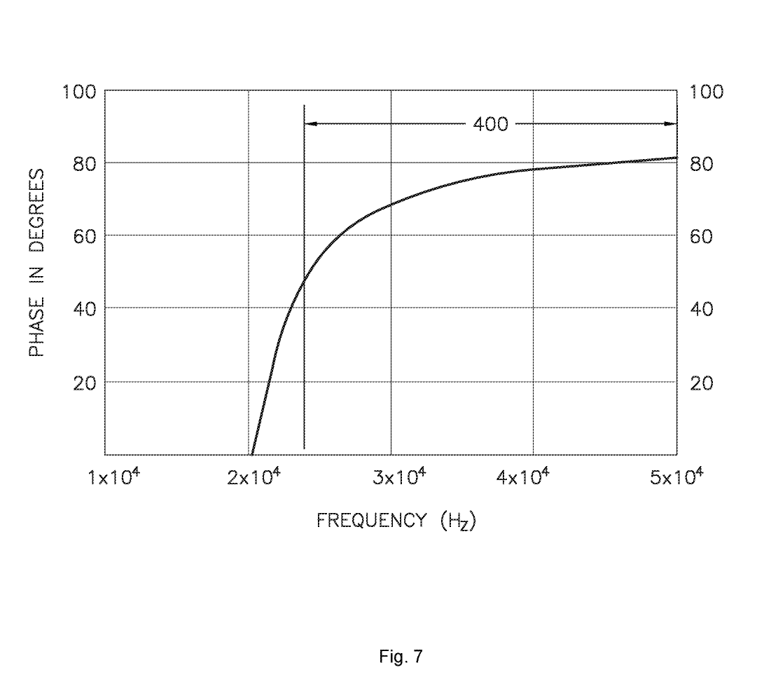

A desirable loading condition and resonant characteristics for the resonant inverter module 360 (FIG. 3) of the induction heating system 300, e.g., such as the example circuit illustrated in FIG. 4, may be defined in terms of the resistance, inductance, and capacitance of the various components of the resonant tank which are described above. Based on these characteristic values of the resonant inverter, coil current magnitude and phase shift in terms of frequency can be determined. FIG. 6 provides an exemplary graph of coil current magnitude (in Amps) in terms of frequency, e.g., FIG. 6 is a graph of ∥i_{L}(jω)∥ for an exemplary resonant inverter. Also noted in FIG. 6 is an operating frequency range 400 of the inverter. As mentioned above, the operating frequency range may be between about 25 kHz and about 50 kHz. As used herein, terms of approximation such as “generally,” “about,” or “approximately” include values within ten percent greater or less than the stated value. FIG. 7 provides a graph of phase shift, in degrees, in terms of frequency, e.g., θ(j w) for an exemplary resonant inverter, including within the operating frequency range 400. In additional exemplary embodiments, the phase shift may also be quantified in radians or any other suitable unit of measure.

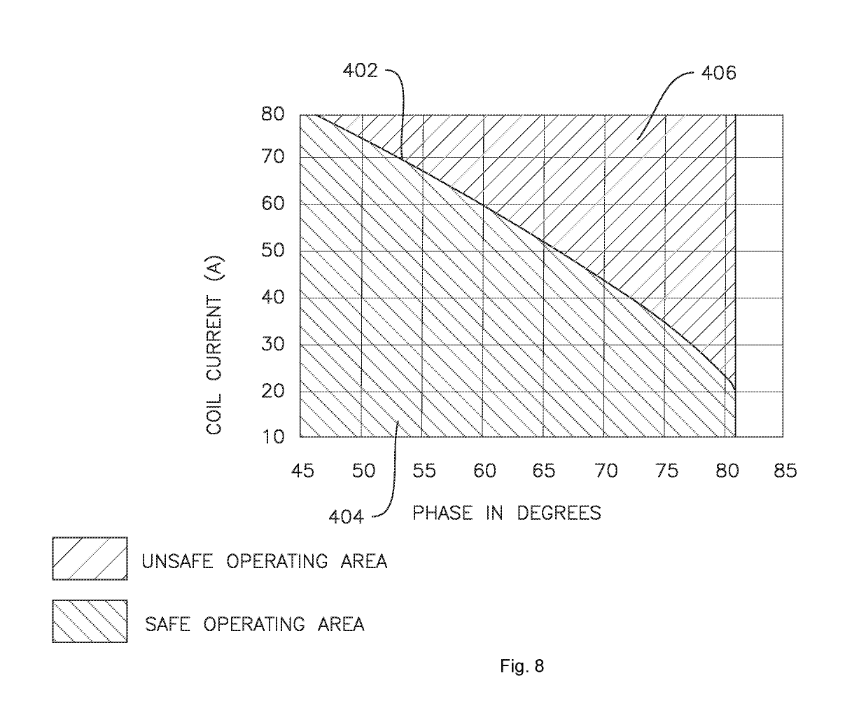

An equation describing a relationship between current and phase angle, e.g., ∥i_{L}(θ(jω))∥ or θ(∥i_{L}(jω))∥), within the operating frequency range 400 can be determined. Generally, the relationship between current and phase angle is linear within the operational frequency range 400. Such linear relationship may generally take the form of: i_{L_MAX}=m×Phase_{Deg}+b; where “m” and “b” are constants which may be selected based on the particular application, e.g., based on the particular inverter module used in various embodiments, such as based on the switch type, e.g., IGBT or MOSFET, provided. For example, FIG. 8 plots an exemplary line 402 which represents maximum current values (i_{L_MAX}) within the operating frequency range 400. The maximum current values are determined based on the phase angle in degrees (Phase_{Deg}) and in the illustrated example of FIG. 8, the constants m and b are equal to 1.86 and 171, respectively. As shown in FIG. 8, the line 402 demarcates a boundary between a safe operating area 404 and an unsafe operating area 406. Current magnitudes below line 402 are considered “safe” in that undesired operation, e.g., hard-switching, may be reduced or avoided when a current supplied to the induction coil 22 is within the safe operating area 404.

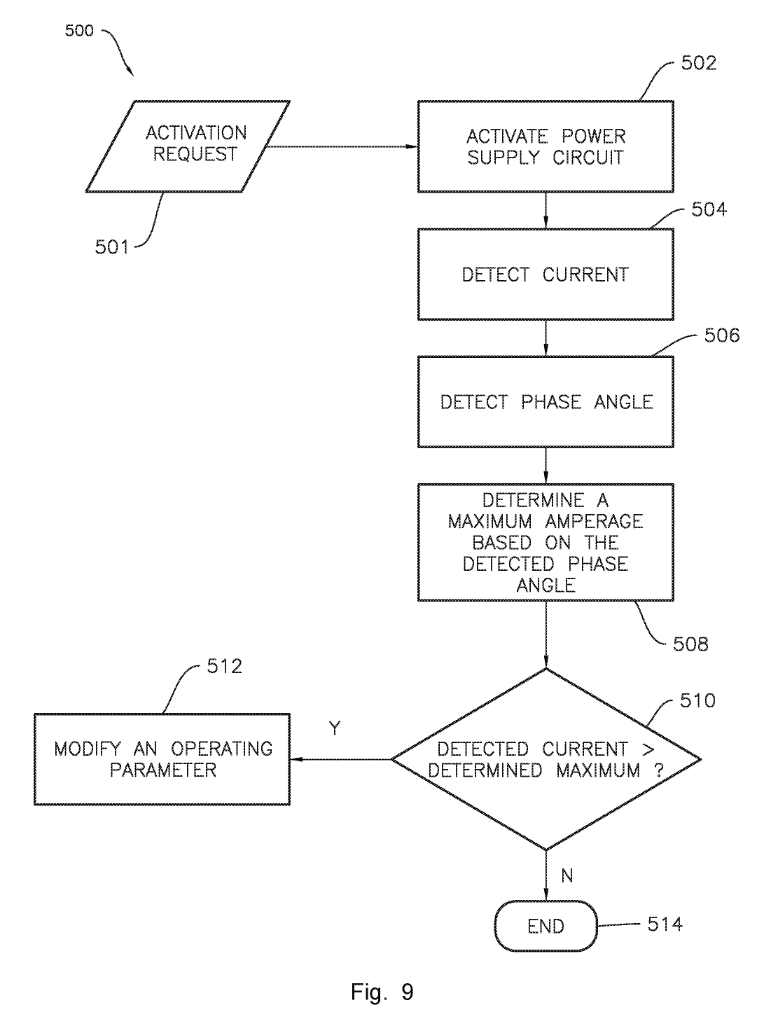

FIG. 9 provides a flow chart illustrating an exemplary method 500 of operating an induction cooktop appliance, such as the illustrated exemplary induction cooktop appliance 10. As shown in FIG. 9, the method 500 may be initiated upon receiving a request, e.g., via user input 31 (FIG. 1), to activate the cooktop appliance at step 501. In response to the request received at 501, the method may include activating a power supply circuit (e.g., AC power supply 308 of FIG. 4) at step 502 to supply a power signal (e.g., power signal 301 of FIG. 4) to an induction heating element of the induction cooktop appliance. The method 500 may also include one or more detecting steps, e.g., using detection circuit 310 of FIG. 3. For example, the method 500 may include detecting a current, e.g., amperage, of the power signal supplied to the induction heating element at step 504 and detecting a phase angle, e.g., in degrees, of the power signal supplied to the induction heating element at step 506.

Method 500 may further include a step 508 of determining a maximum current based on the detected phase angle. For example, the maximum current may be determined based on a linear relationship between the maximum current and the detected phase angle. One possible example of such linear relationship is i_{L_MAX}=m×Phase_{Deg}+b, as described above. The current detected at step 504 may be compared to the calculated or determined maximum current from step 508 at step 510. When the detected current is less than the determined maximum current, the method 500 may end at 514. In other embodiments, the method 500 may include continuous or repeated monitoring, e.g., the method 500 may return to step 504 after step 510 when the detected current is less than the determined maximum current, e.g., directly after step 510 or after a predetermined time delay following step 510. When the detected current is greater than the determined maximum current at step 510, the method 500 may proceed to a step 512 of modifying an operating parameter of the induction cooktop appliance, in particular the power supply circuit thereof, when the detected current is greater than the determined maximum current.

For example, in some embodiments, the step 512 of modifying the operating parameter may include performing a cycle-skipping mode. The cycle-skipping mode may include activating the power supply circuit for a first period of time, deactivating the power supply circuit for a second period of time after the first period of time, and activating the power supply circuit for a third period of time after the second period of time.

As another example, in additional embodiments, the step 512 of modifying the operating parameter may include increasing a switching frequency of the inverter. As may be seen with reference to FIG. 6, increasing the switching frequency results in a decrease in the amperage of the coil current. Also as may be seen in FIG. 6, the corresponding decrease in coil current when the frequency increases becomes smaller above about 30 kHz. Accordingly, in some embodiments, method 500 may also include detecting a second current after increasing the switching frequency of the inverter, detecting a second phase angle after increasing the switching frequency of the inverter, and determining a second maximum current based on the detected second phase angle. In such embodiments, the method 500 may then further include modifying an operating parameter of the power supply circuit when the detected second current is greater than the determined second maximum current.

As another example, in additional embodiments, the step 512 of modifying the operating parameter may include deactivating the power supply circuit when the detected current is greater than the determined maximum current. In particular, when the detected current is significantly greater than the determined maximum current, the power supply circuit may simply be deactivated. For example, the power supply circuit may be deactivated when the detected current is approximately one hundred twenty percent (120%) of the determined maximum current or greater, such as approximately one hundred fifty percent (150%) of the determined maximum current or greater, such as approximately two hundred percent (200%) of the determined maximum current or greater.

In various embodiments, for example but not limited to embodiments wherein the step 512 includes deactivating the induction cooktop appliance and/or the power supply circuit thereof, method 500 may further include providing an indication via a display (e.g., display 32 in FIG. 1) of the user interface when the detected current is greater than the determined maximum current. Such indication may prompt a user to select a more compatible cookware for use with the induction cooktop appliance and/or may prevent excessive service calls as a user may be informed by the indication that the cooktop appliance is functioning as intended even though cooking performance may be degraded (e.g., slower) as a result of the poor coupling and/or modified operating parameters.

One of skill in the art will understand that the risk of hard switching and other undesirable operations is increased at higher power operation. Accordingly, in some embodiments, the activation request received at step 501, as described above, may be a request for high-power operation. For example, a user input 31 may provide options to a user ranging from “Low” to “High,” from 1 to 10, or any other suitable range. In such embodiments, a request for high-power operation may include setting the heating element 20 to, e.g., “High” or “Medium-High,” or to a setting of 6 or more out of 10. The foregoing examples of “a request for high-power operation” are provided for illustrative purposes only and are not intended to be limiting. Further, in some embodiments, the method 500 may include or proceed to the detection steps 504 and 506 and the determination step 508 as well as other subsequent steps only when the request received via the user input is a request for high-power operation.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An induction cooktop appliance, comprising:
a user interface comprising a user input;
an induction heating element operable to inductively heat a load with a magnetic field;
a power supply circuit configured to supply a power signal to the induction heating element, the power supply circuit comprising an inverter; and
a control circuit configured to control the power supply circuit, the control circuit configured to:
activate the power supply circuit in response to a request received via the user input;
detect a current of the power signal supplied to the induction heating element;
detect a phase angle of the power signal supplied to the induction heating element;
determine a maximum current based on the detected phase angle;
compare the detected current to the determined maximum current; and
modify an operating parameter of the power supply circuit when the detected current is greater than the determined maximum current.

2. The induction cooktop appliance of claim 1, wherein the control circuit is further configured to determine the maximum current based on a linear relationship between the maximum current and the detected phase angle.

3. The induction cooktop appliance of claim 1, wherein modifying the operating parameter comprises performing a cycle-skipping mode, and wherein the cycle-skipping mode comprises activating the power supply circuit for a first period of time, deactivating the power supply circuit for a second period of time after the first period of time, and activating the power supply circuit for a third period of time after the second period of time.

4. The induction cooktop appliance of claim 1, wherein modifying the operating parameter comprises increasing a switching frequency of the inverter.

5. The induction cooktop appliance of claim 4, wherein the control circuit is further configured to:
detect a second current after increasing the switching frequency of the inverter;
detect a second phase angle after increasing the switching frequency of the inverter;
determine a second maximum current based on the detected second phase angle; and
modify an operating parameter of the power supply circuit when the detected second current is greater than the determined second peak current.

6. The induction cooktop appliance of claim 1, wherein modifying the operating parameter comprises deactivating the power supply circuit when the detected current is approximately one hundred twenty percent of the determined maximum current or greater.

7. The induction cooktop appliance of claim 1, wherein the inverter is a half-bridge resonant inverter.

8. The induction cooktop appliance of claim 1, wherein the control circuit is further configured to provide an indication via a display of the user interface when the detected current is greater than the determined maximum current.

9. The induction cooktop appliance of claim 1, wherein the request received via the user input is a request for high-power operation.

10. A method of operating an induction cooktop appliance, comprising:
supplying a power signal to an induction heating element of the induction cooktop appliance in response to a request received via a user input of the cooktop appliance;
detecting a current of the power signal supplied to the induction heating element;
detecting a phase angle of the power signal supplied to the induction heating element;
determining a maximum current based on the detected phase angle;
comparing the detected current to the determined maximum current; and
modifying an operating parameter of the induction cooktop appliance when the detected current is greater than the determined maximum current.

11. The method of claim 10, wherein determining the maximum current based on the detected phase angle comprises determining the maximum current based on a linear relationship between the maximum current and the detected phase angle.

12. The method of claim 10, wherein modifying the operating parameter comprises performing a cycle-skipping mode, and wherein the cycle-skipping mode comprises supplying the power signal for a first period of time, discontinuing the power signal for a second period of time after the first period of time, and supplying the power signal for a third period of time after the second period of time.

13. The method of claim 10, wherein modifying the operating parameter comprises increasing a switching frequency of an inverter of a power supply circuit of the induction cooktop appliance.

14. The method of claim 13, further comprising:
detecting a second current after increasing the switching frequency of the inverter;
detecting a second phase angle after increasing the switching frequency of the inverter;
determining a second maximum current based on the detected second phase angle; and
modifying an operating parameter of the power supply circuit when the detected second current is greater than the determined second peak current.

15. The method of claim 13, wherein the inverter is a half-bridge resonant inverter.

16. The method of claim 10, wherein modifying the operating parameter comprises deactivating the induction cooktop appliance when the detected current is approximately one hundred twenty percent of the determined maximum current or greater.

17. The method of claim 10, further comprising providing an indication via a user interface display when the detected current is greater than the determined maximum current.

18. The method of claim 10, wherein the request received via the user input is a request for high-power operation.
